(19) United States
(12) Patent Application Publication
(10) Pub. No.: US 2015/0031232 A1
(43) Pub. Date: Jan. 29, 2015

(54) ELECTRONIC COMPONENT LATCH

(71) Applicant: International Business Machines Corporation, Armonk, NY (US)

(72) Inventors: Brian M. Kerrigan, Cary, NC (US); Timothy A. Meserth, Durham, NC (US); Tony C. Sass, Fuquay Varina, NC (US); Jean J. Xu, Cary, NC (US)

(73) Assignee: International Business Machines Corporation, Armonk, NY (US)

(21) Appl. No.: 13/949,604

(22) Filed: Jul. 24, 2013

(51) Int. Cl. H01R 12/70

(52) U.S. Cl. CPC H01R 12/7058
USPC 439/366

(57) ABSTRACT

An apparatus and method are provided for securing an electronic component in an interface slot. In an embodiment of the apparatus, a pivoting latch may be provided, that in a first position retains the electronic component in an interface slot. The apparatus may further include a push point of the latch for movement of the latch to a second position. The apparatus may further include a guide at the push point of the latch for receiving a tool.

### TECHNICAL FIELD

This disclosure generally relates to electronic components, and in particular, to securing electronic components in an interface slot.

### BACKGROUND

Modern electronic devices, such as computer systems, use electronic components. Often these components are made to fit into specific interface slots. Such electronic components may allow the electronic device to operate or be used to improve or expand on the capabilities of the electronic device. Securing these electronic components in the interface slots may be required to prevent loss of these capabilities or prevent system failures.

### SUMMARY

An apparatus and method are provided for securing an electronic component in an interface slot. In an embodiment of the apparatus, a pivoted latch may be provided, that in a first position retains the electronic component in an interface slot. The apparatus may further include a push point on the latch for movement of the latch to a second position. The apparatus may further include a guide at the push point of the latch for receiving a tool.

In another embodiment, a method is provided for releasing an electronic component from an interface slot. The method may include, placing a tool in a guide at a push point of a latch in a first position, the latch in the first position retaining the electronic component in the interface slot. The method may further include, applying pressure to the tool, the pressure sufficient to move the latch to a second position. In the second position the latch may allowing the electronic component to be removed from the interface slot.

### BRIEF DESCRIPTION OF THE DRAWINGS

Embodiments are illustrated by way of example, and not by way of limitation, in the figures of the accompanying drawings in which like reference numerals refer to similar elements or steps.

FIG. 1A shows a schematic representation of an electronic component positioned to be installed into a receptacle according to one embodiment.

FIG. 1B shows a schematic representation of an electronic component installed in the receptacle of FIG. 1A, according to an embodiment of the invention.

FIG. 2A is a schematic representation of a top section of a latch, according to an embodiment of the invention.

FIG. 2B is a schematic representation of a top view of the push point of the latch in FIG. 1B, according to an embodiment of the invention

FIG. 3 is a flowchart illustrating a method, according to an embodiment of the invention.

### DETAILED DESCRIPTION

In many systems such as electronic devices, for example a computer system, electronic components (herein after component) may be attached or retained using latches. These latches may be pivoted such that they may move to engage the component to be retained by them. The pivoting movement of the latches may be rotational or sideways to engage or disengage the components. A common component that uses a latch for retention is memory. For example, a type of memory, a dual in-line memory module (DIMM), may be inserted into interface slot and one or more latches may be used to retain the DIMM in place. The latches may insure the DIMM does not lose electronic connection with elements in the interface slot and prevent the DIMM from shifting if the electronic device containing the DIMM is moved around. The use of latches for retaining components is common and these latches may be designed to be engaged by a human finger. The finger may apply pressure on a specific point of the latch to move the latch or cause the latch to engage or disengage with the component.

As electronic devices have grown in complexity and power they have also often been designed to be reduced in size. These demands on the electronic devices and computer systems have made real estate within them a luxury. With more components often installed into a smaller space accessing latches for retaining components, either to install, remove, or access may be difficult. The latch may be designed to interact with a human finger that may not be able to reach between other elements or components inside the electronic device to interact with the latch. Embodiments of the presented disclosure may make it possible for a user to interact with the latch, such as engaging the latch in a first position or disengaging the latch in a second position, without the direct contact of a human finger and thus, possibly reducing space concerns inside the electronic device for accessibility.

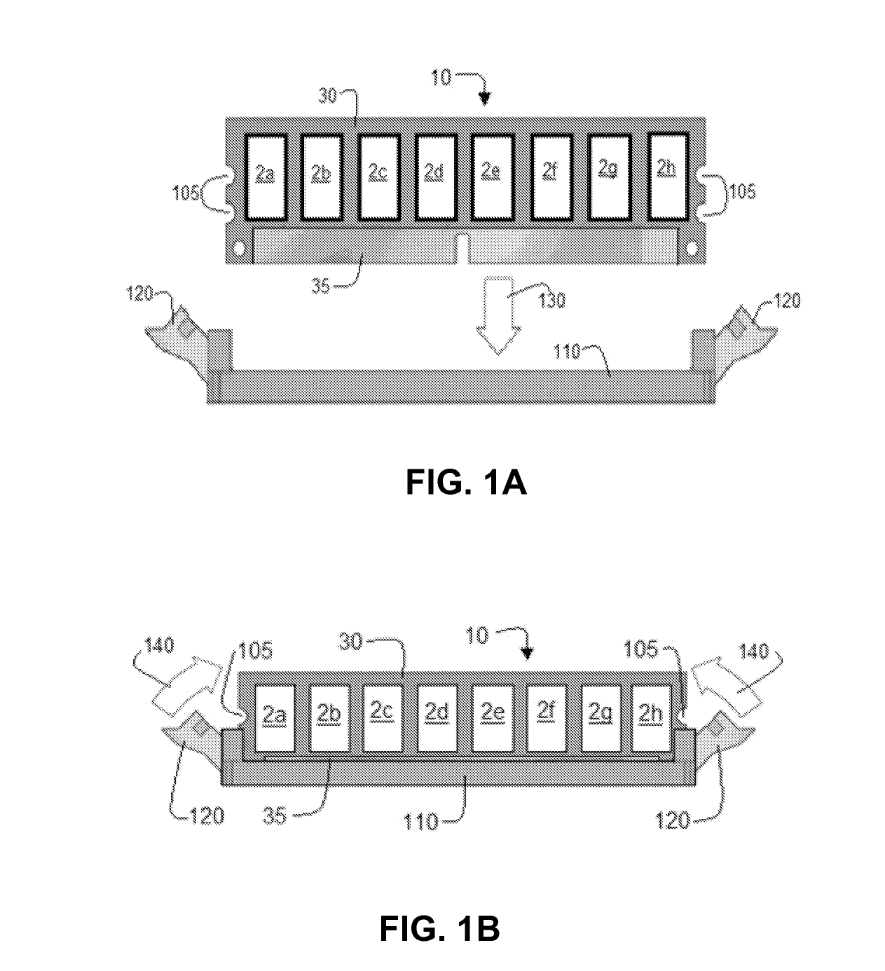

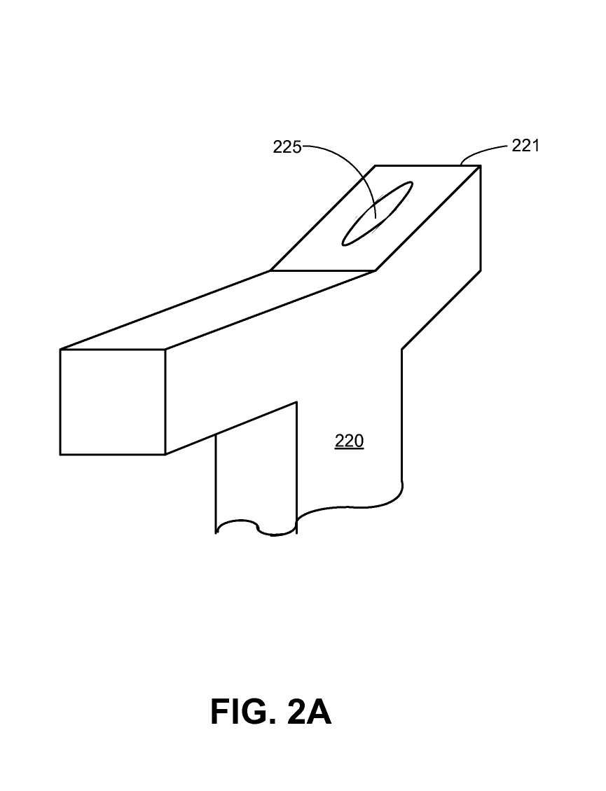

FIGS. 1A and 1B are schematic representations of an electronic component 10 positioned to be installed into an interface slot 110 and latches 120 positioned to retain the electronic component 10 once installed, according to an embodiment of the invention. In FIG. 1A, the electronic component 10 is oriented for installation in an interface slot 110 with an arrow 130 indicating the direction of insertion, according to an embodiment of the invention. In the illustrated example, the latches 120 are in lowered position to permit the electronic component 10 to be installed in the interface slot 110.

The illustrated embodiment of the electronic component 10 may include a multiplicity of electronic devices 2a through 2h (collectively hereafter referred to as 2) which are mounted on a circuit board 30. The circuit board 30 may have a connector 35. In various embodiments, the circuit board 30 may be a printed circuit board (PCB), printed wiring board (PWB), etched wiring board, or other body for mounting and electrically connecting electronic devices. In various embodiments, the electronic device mounted to the circuit board 30 may include, but is not limited to, any of the following: microprocessors, capacitors, resistors, inductors, semi-conductor elements, integrated circuits, chip carriers, or any electric devices designed or modified for mounting on a circuit board 30.

Connector 35 may be used to interface the electronic component 10 with other electronics, allowing for the transfer of information, and may optionally provide a conduit for electric power to the electronic component 10. In one embodiment, the connector 35 may be a computer bus interface connector, one example of which is a Peripheral Component Interconnect Express (PCIe) style edge connector. In another embodiment, the connector 35 may be a computer memory edge connector, communication socket, or a board-to-board connector. In another embodiment, the connector 35 may be of an optical type. One embodiment of the electronic component 10 may be a memory module. In other embodiments, this electronic component 10 may be a graphics card, network card, expansion card, adaptor card, interface card, server component, server blades, or other electronic component. It is contemplated that additional forms of connector 35 or electronic component 10 may be employed and still remain within the scope and spirit of the presented embodiments of the invention. In the various embodiments, the interface slot may match the connector type of the component. These interface slot types may include, but are not limited to, computer bus interface slots, memory module slots, DIMM memory module slots, or PCI interface slots.

In the illustrated embodiment, a proximal end of the electronic component 10 is the end with the connector 35. A distal end of the electronic component 10 is the side opposite proximal end. In various embodiments, the distal end of the electronic component 10 is the end of the component that may have force applied to it for installing the electronic component 10 into an installed position.

FIG. 1B shows the same embodiment with the electronic component 10 having been inserted in interface slot 110 and the latches 120 are shown being moved into a locked position to secure the component in the interface slot. Here, the latches 120 may snap into notches 105 formed within the component 10 to lock it into place with interface slot 110. Other embodiments of the interface slot 110 may employ varying numbers of latches 120. In other embodiments, the latches 120 may connect with the electronic component 10 using clips, pins, or hooks. In other embodiments, the electronic component may have fewer or more connection points, such as the notches 105, shown in the illustrated example. The connection points on the electronic device 10 may include, but are not limited to, holes, recesses, retainers. In various embodiments, the retention method may be reversed between the electronic component 10 and the latch 120. For example, the latch 120 may have a notch or a hole that a hook or a retainer may interact with on the electronic device 10. The latch 120 may be moved by applying pressure to one end or point as described below.

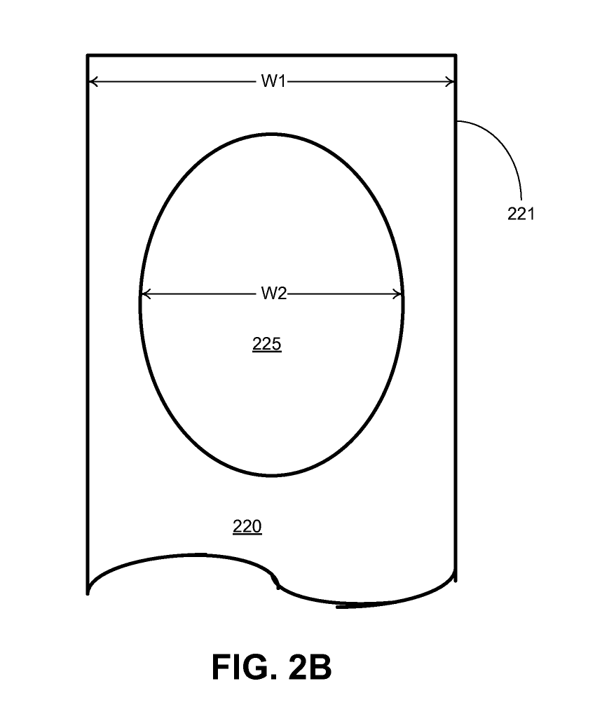

FIG. 2A is a schematic representations of a top section of a latch 220, according to an embodiment of the invention. The top section depicted is opposite the bottom section of the latch 220 where the pivot point or connection may be for the latch. The top section of the latch may have a push point 221. The push point 221 may be a section of the latch that when pressure is applied the latch may pivot. In various embodiments, the push point 221 may activate a release of the latch 220. For example, pressure used on the push point 221 may transfer through the latch 220 to release connectors locking the latch into position either on the component being retained by the latch or in elements of the electronic device the latch is in contact with. In various embodiments, this release may include mechanical elements such as springs or actuating elements. In various other embodiments, the release activated may be obtained by bowing caused by the pressure at the push point 221 of the latch 220. In various embodiments, the push point 221 may be the part or section of the latch designed for interaction with a human appendage, such as a finger, to move the latch into or out of locked position. In various embodiments, the push point may be known as the pivot arm, lever point, pressure point, or moment arm.

The illustrated embodiment may also have a guide 225 located at the push point 221 of the latch 220. The guide 225 may be of a size or shape to allow for an object, or tool, to be inserted into it such that pressure or force used on the tool may be transferred to the push point 221 of the latch 220 and thus the latch 220 may be moved or released using the object. In various embodiments, a different pressure amount, direction, or angle may be used to reverse the movement of the latch. In such embodiments, sufficient pressure may be added to a tool in the guide 225 to move the latch 220 from the second position of release to the first position of retaining the electronic component 10 in the interface slot 110.

FIG. 2B is a schematic representations of a top view of the push point 221 of the latch 220, according to an embodiment of the invention. The guide 225 can be seen positioned in the push point 221. In the illustrated embodiment, the guide 225 is located centrally on the push point 221 and is an oval with an opening width of W2. In various other embodiments, the guide may be of various other shapes. For example, the guide may be, but is not limited to, circular, triangular, square, rectangle, or a polygon. In various embodiments, the guide 225 may not be located centrally on the push point. For example the guide 225 may be located more towards the end of the push point 221 to provide better leverage for pressure applied to a tool inserted into the guide 225 to change the latch 220 position or cause the latch 220 to release. The depth of the guide may vary between embodiments. In various embodiments, the guide may pass entirely through the push point 221. In other embodiments, the guide may be a depression in the push point. For example, the guide may be only 0.5 mm deep or some other depth. The opening width W2 of the guide 225 may be less than the width W1 of the push point 221.

The guide 225 may be of a size and shape to match the anticipated tool used to apply pressure to the push point 221 of the latch 220. For example the guide 225 may be designed to accept the end of a pen. In such embodiments, the guide 225 may be circular and have an opening width W2 of 5 mm and a depth of 1 mm or more. This opening width W2 may be large enough to accept the end, or tip, of a pen used by an individual to exert pressure on the push point 221 of the latch 220 to change position or release the latch 220. In other embodiments, the guide 225 may be “X” shaped with an opening width W2 of only 2 mm to accept the end of a P0 size Philips screwdriver. In various embodiments, the opening width W2 may be between 1 mm, the size of a small rigid wire, and less than 13 mm, the size of a small finger. In various embodiments, the guide 225 may be squared off at the bottom or may be concave depending on the tool designed to be accepted by the guide 225. Some guides 225 may be designed to handle a variety of possible generic tools, such as, but not limited to pens, small screwdrivers, or rigid metal wires.

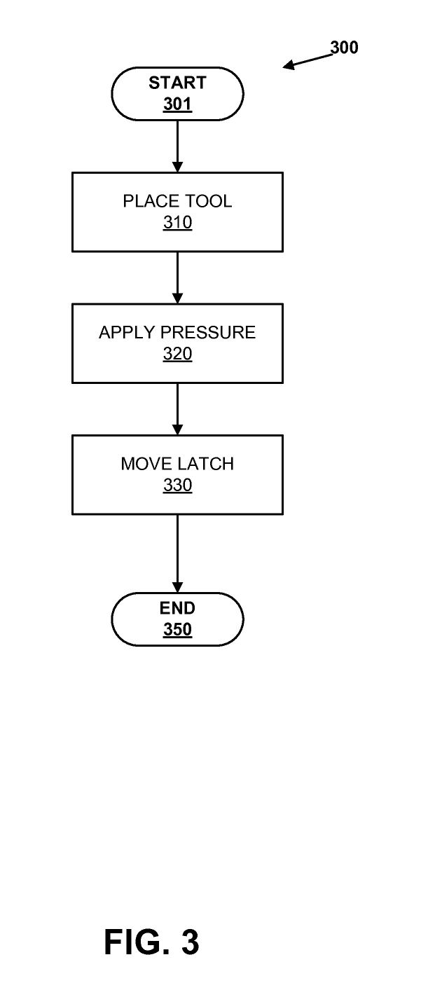

FIG. 3 is a flowchart of a method 300 for releasing the electronic component 10 from the interface slot 110, according to an embodiment. The method 300 may start in block 301. In block 310, the latch 220 may be in a first position retaining the electronic component 10 in the interface slot 110. The tool, previously described, may be placed in the guide 225 located at the push point 221 of the latch 220, as also previously discussed. In block 320, sufficient pressure may be applied to the tool such that the pressure on the tool may move the latch 220. In block 330, the latch 220 may move to a second position allowing the electronic component 10 to be removed from the interface slot 110. The method may then end in block 350.

In various embodiments, the latch 220 moving to the second position may include displacement of the electronic component 10 from the interface slot 110 such that electronic communication may discontinue. In various embodiments, the pressure sufficient to move the latch 220 to the second position may include the pressure on the push point 221 that may release connectors locking the latch 220 into position either on the electronic component 10 being retained by the latch 220 or in elements of the electronic device the latch 220 is in contact with. In various embodiments, the method may be reversed such that sufficient pressure may be added to a tool in the guide 225 to move the latch 220 from the second position of release to the first position of retaining the electronic component 10 in the interface slot 110.

While this disclosure has described the details of various embodiments shown in the drawings, these details are not intended to limit the scope of the invention as claimed in the appended claims.

What is claimed is:

1. An apparatus for securing an electronic component in an interface slot, comprising:
a pivoting latch, that in a first position retains the electronic component in the interface slot;
a push point of the latch for movement of the latch to a second position; and
a guide at the push point of the latch for receiving a tool.

2. The apparatus of claim 1, wherein the push point on the latch is configured to activate a release of the latch when the latch is in the first position.

3. The apparatus of claim 1, wherein the electronic component is a dual in-line memory module (DIMM).

4. The apparatus of claim 1, wherein the interface slot includes a computer bus interface connector.

5. The apparatus of claim 1, wherein the interface slot is a memory module slot.

6. The apparatus of claim 5, wherein the memory module slot is a dual in-line memory module (DIMM) memory module slot.

7. The apparatus of claim 1, wherein the guide has an opening width equal to or greater than 1 mm.

8. The apparatus of claim 1, wherein the guide has an opening width equal to or less than 13 mm.

9. The apparatus of claim 1, wherein the tool to be received by the guide is a pen.

10. The apparatus of claim 1, wherein the tool to be received by the guide is a screwdriver.

11. A method for releasing an electronic component from an interface slot, comprising:
placing a tool in a guide at a push point of a latch in a first position, the latch in the first position retaining the electronic component in the interface slot; and
applying pressure to the tool, the pressure sufficient to move the latch to a second position, the latch in the second position allowing the electronic component to be removed from the interface slot.

12. The method of claim 11, wherein the push point of the latch activates a release of the latch when the latch is in a first position.

13. The method of claim 11, wherein the electronic component is a dual in-line memory module (DIMM).

14. The method of claim 11, wherein the interface slot includes a computer bus interface connector.

15. The method of claim 11, wherein the interface slot is a memory module slot.

16. The method of claim 15, wherein the memory module slot is a dual in-line memory module (DIMM) memory module slot.

17. The method of claim 11, wherein the guide has an opening width equal to or greater than 1 mm.

18. The apparatus of claim 11, wherein the guide has an opening width equal to or less than 13 mm.

19. The method of claim 11, wherein the tool is a pen.

20. The method of claim 11, wherein the tool is a screwdriver.
